(19) United States
(12) Patent Application Publication
(10) Pub. No.: US 2019/0276003 A1
(43) Pub. Date: Sep. 12, 2019

(54) CONTROL DEVICE FOR HYBRID VEHICLE

(71) Applicant: TOYOTA JIDOSHA KABUSHIKI KAISHA, Toyota-shi (JP)

(72) Inventor: Yuta Tsukada, Shizuoka-ken (JP)

(73) Assignee: TOYOTA JIDOSHA KABUSHIKI KAISHA, Toyota-shi (JP)

(21) Appl. No.: 16/285,603

(22) Filed: Feb. 26, 2019

(30) Foreign Application Priority Data
Mar. 6, 2018 (JP) 2018-039953

(51) Int. Cl. B60W 20/13; B60W 10/06; B60W 10/08

(52) U.S. Cl. CPC B60W 20/13; B60W 2510/244; B60W 10/08; B60W 10/06

(57) ABSTRACT

A control device for a hybrid vehicle is configured to, when regenerative electric power of a drive motor exceeds an upper limit value of charging electric power permitted for the battery, perform control such that the power generation motor is power-driven using electric power corresponding to a differential value between the regenerative electric power of the drive motor and the upper limit value of the charging electric power permitted for the battery to rotationally drive the engine, and when the regenerative electric power of the drive motor falls below the upper limit value of the charging electric power permitted for the battery, perform control such that the power generation motor is regeneratively driven to convert kinetic energy of the engine to electric energy and to charge the battery with the electric energy.

### INCORPORATION BY REFERENCE

The disclosure of Japanese Patent Application No. 2018-039953 filed on Mar. 6, 2018 including the specification, drawings and abstract is incorporated herein by reference in its entirety.

### BACKGROUND

### 1. Technical Field

The present disclosure relates to a control device for a hybrid vehicle.

### 2. Description of Related Art

Japanese Unexamined Patent Application Publication No. 2001-238303 (JP 2001-238303 A) describes a control device for a hybrid vehicle in which, when chargeable electric power falls below regenerative electric power of an electric motor, a power generator is driven with a surplus of regenerative electric power to forcibly operate an engine, thereby consuming the surplus of the regenerative electric power in an engine brake.

### SUMMARY

With the control device for a hybrid vehicle described in JP 2001-238303 A, since the surplus of the regenerative electric power is consumed by the engine brake, there is a possibility that the surplus of the regenerative electric power is not recovered to a battery and fuel efficiency is deteriorated.

The present disclosure provides a control device for a hybrid vehicle capable of suppressing deterioration of fuel efficiency by consuming a surplus of regenerative electric power.

An aspect of the present disclosure relates to a control device for a hybrid vehicle. The hybrid vehicle includes an engine, a battery, a power generation motor connected to an output shaft of the engine, and a drive motor connected to a drive shaft coupled to drive wheels. The control device includes an electronic control unit. The electronic control unit is configured to, when regenerative electric power of the drive motor exceeds an upper limit value of charging electric power permitted for the battery, perform control such that the power generation motor is power-driven using electric power corresponding to a differential value between the regenerative electric power of the drive motor and the upper limit value of the charging electric power permitted for the battery to rotationally drive the engine. The electronic control unit is configured to, when the regenerative electric power of the drive motor falls below the upper limit value of the charging electric power permitted for the battery, perform control such that the power generation motor is regeneratively driven to convert kinetic energy of the engine to electric energy and to charge the battery with the electric energy.

In the control device according to the above-described aspect, the electronic control unit may be configured to, when there is a stop request of the engine at the time of deceleration of the hybrid vehicle, execute stop control of the engine after the differential value between the regenerative electric power of the drive motor and the upper limit value of the charging electric power permitted for the battery exceeds maximum electric power needed for the stop control of the engine. According to such a configuration, the rotation speed of the engine quickly passes through a resonance frequency bandwidth of a damper during a stop operation of the engine, and it is possible to suppress the occurrence of torque fluctuation or vibration noise of the engine.

According to the aspect of the present disclosure, when the regenerative electric power of the drive motor falls below the upper limit value of the charging electric power permitted for the battery, since the kinetic energy of the engine is converted to the electric energy and the battery is charged with the electric energy, it is possible to suppress deterioration of fuel efficiency by consuming a surplus of the regenerative electric power.

### BRIEF DESCRIPTION OF THE DRAWINGS

Features, advantages, and technical and industrial significance of exemplary embodiments of the present disclosure will be described below with reference to the accompanying drawings, in which like numerals denote like elements, and wherein:

FIG. 1 is a schematic view showing the configuration of a hybrid vehicle to which a control device for a hybrid vehicle according to an embodiment of the present disclosure is applied;

FIG. 2 is a flowchart showing a flow of braking control processing according to embodiment of the present disclosure;

FIG. 3A is a diagram illustrating the effect of braking control processing in the related art;

FIG. 3B is a diagram illustrating the effect of the braking control processing in the related art;

FIG. 3C is a diagram illustrating the effect of the braking control processing in the related art;

FIG. 4A is a diagram illustrating the effect of the braking control processing according to the embodiment of the present disclosure;

FIG. 4B is a diagram illustrating the effect of the braking control processing according to the embodiment of the present disclosure;

FIG. 4C is a diagram illustrating the effect of the braking control processing according to the embodiment of the present disclosure;

FIG. 5 is a diagram illustrating a modification example of the braking control processing according to the embodiment of the present disclosure; and

FIG. 6 is a diagram illustrating a modification example of the braking control processing according to the embodiment of the present disclosure.

### DETAILED DESCRIPTION OF EMBODIMENTS

Hereinafter, the configuration and operation of a control device for a hybrid vehicle according to an embodiment of the present disclosure will be described referring to the drawings.

Configuration of Hybrid Vehicle

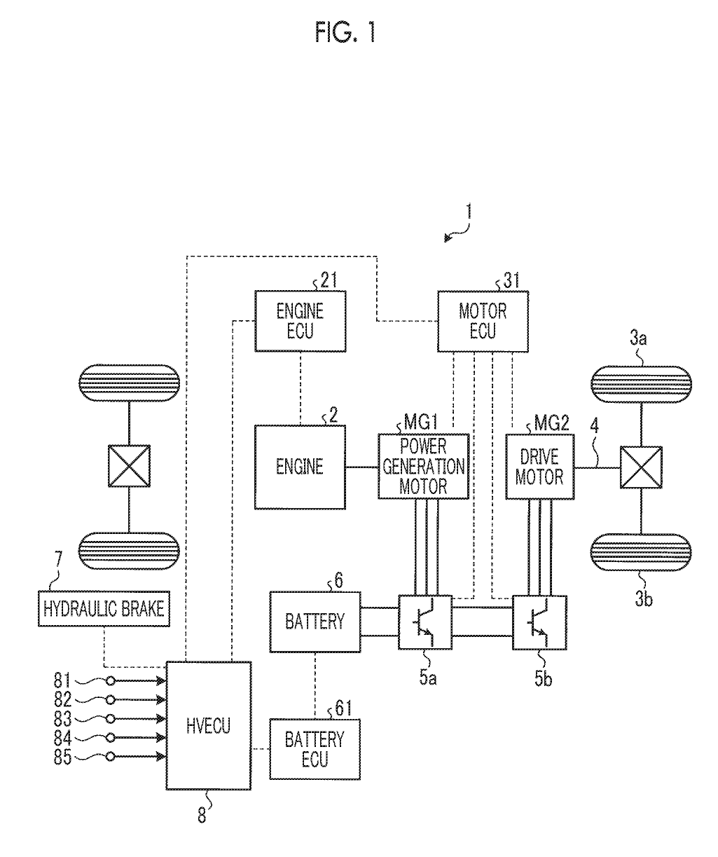

First, the configuration of a hybrid vehicle to which the control device for a hybrid vehicle according to the embodiment of the present disclosure is applied will be described referring to FIG. 1.

FIG. 1 is a schematic view showing the configuration of the hybrid vehicle to which the control device for a hybrid vehicle according to the embodiment of the present disclosure is applied. As shown in FIG. 1, a hybrid vehicle 1 to which the control device for a hybrid vehicle according to the embodiment of the present disclosure is applied is constituted of a so-called series hybrid vehicle in which a motor for power generation (power generation motor) MG1 is connected to an output shaft of an engine 2 and a motor for traveling (drive motor) MG2 is connected to a drive shaft 4 coupled to drive wheels 3a, 3b. In detail, the hybrid vehicle 1 includes, as principal constituent elements, the engine 2, the power generation motor MG1, the drive motor MG2, inverters 5a, 5b, a battery 6, a hydraulic brake 7, and an electronic control unit for a hybrid vehicle (hereinafter, referred to as a hybrid vehicle electronic control unit (HVECU)) 8.

The engine 2 is constituted of an internal combustion engine that outputs power using fuel, such as gasoline or diesel oil. The engine 2 is subjected to operation control by an electronic control unit for an engine (hereinafter, referred to as an engine ECU) 21. The engine ECU 21 is constituted of a microprocessor, and includes a central processing unit (CPU), a read only memory (ROM) that stores a control program, a random access memory (RAM) that temporarily stores data, an input/output port, a communication port, and the like. The engine ECU 21 is connected to the HVECU 8 through the communication port.

The power generation motor MG1 is constituted of a synchronous motor generator, and has a rotor connected to the output shaft of the engine 2. The drive motor MG2 is constituted of a synchronous motor generator, and has a rotor connected to the drive shaft 4. The inverters 5a, 5b are connected to the power generation motor MG1 and the drive motor MG2, respectively, and are connected to the battery 6 through an electric power line. The power generation motor MG1 and the drive motor MG2 are rotationally driven through switching control of a plurality of switching elements in the inverters 5a, 5b using an electronic control unit for a motor (hereinafter, referred to as a motor ECU) 31. The motor ECU 31 is constituted of the same microprocessor as the engine ECU 21. The motor ECU 31 is connected to the HVECU 8 through a communication port.

The battery 6 is constituted of a lithium-ion secondary battery or a nickel-hydrogen secondary battery, and is connected to the inverters 5a, 5b through an electric power line. The battery 6 is managed by an electronic control unit for a battery (hereinafter, referred to as a battery ECU) 61. The battery ECU 61 is constituted of the same microprocessor as the engine ECU 21. The battery ECU 61 is connected to the HVECU 8 through a communication port.

The hydraulic brake 7 is a constituted of a hydraulic brake system, such as a cooperative regenerative electric control braking system (ECB). The hydraulic brake 7 controls a braking operation of the hybrid vehicle 1 in response to a control signal from the HVECU 8.

The HVECU 8 is constituted of the same microprocessor as the engine ECU 21. Signals from various sensors are input to the HVECU 8 through the input port. As the signals that are input to the HVECU 8, an ignition signal from an ignition switch 81, an engine rotation speed signal from an engine rotation speed sensor 82 that detects a rotation speed of the engine 2, an accelerator operation amount signal from an accelerator pedal position sensor 83 that detects a depression amount of an accelerator pedal, a brake pedal position signal from a brake pedal position sensor 84 that detects a depression amount of a brake pedal, a vehicle speed signal from a vehicle speed sensor 85, and the like can be exemplified. The HVECU 8 is connected to the engine ECU 21, the motor ECU 31, and the battery ECU 61 through a communication port.

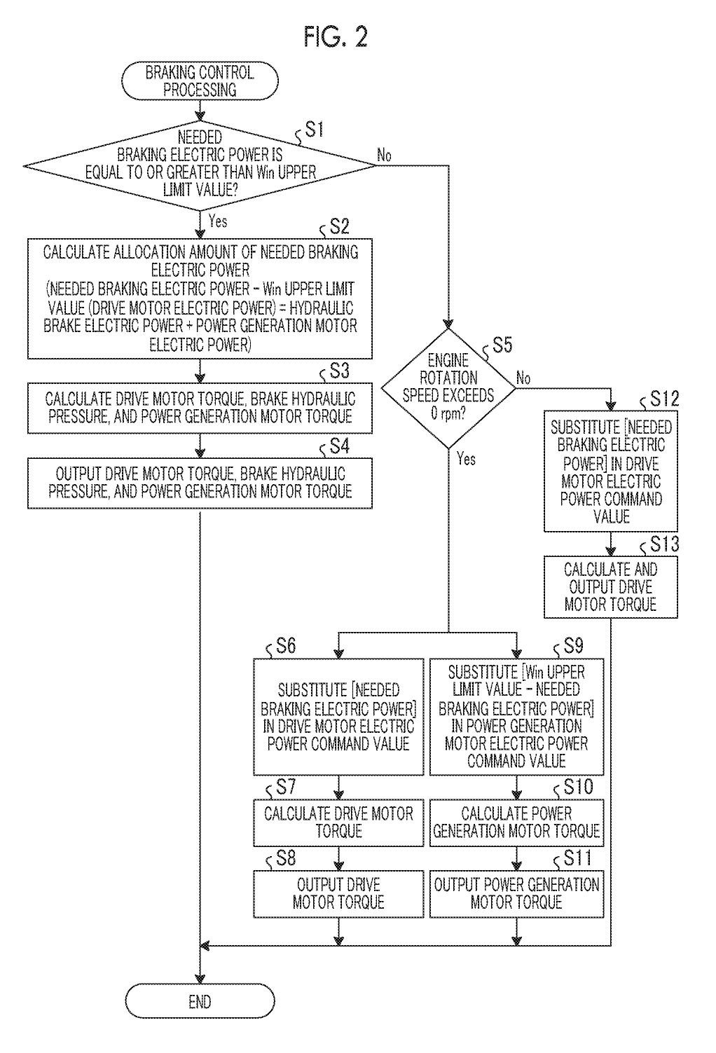

In the hybrid vehicle 1 having such a configuration, the HVECU 8 executes braking control processing described below to consume a surplus amount of regenerative electric power, thereby suppressing deterioration of fuel efficiency of the hybrid vehicle 1. Hereinafter, the operation of the HVECU 8 when the braking control processing is executed will be described referring to FIGS. 2 to 6.

Braking Control Processing

FIG. 2 is a flowchart showing a flow of braking control processing according to the embodiment of the present disclosure. The flowchart shown in FIG. 2 starts at a timing at which a braking command of the hybrid vehicle 1 is input to the HVECU 8, specifically, at a timing at which the brake pedal position signal is output from the brake pedal position sensor 84 when the hybrid vehicle 1 is traveling, and the braking control processing progresses to processing of Step S1. The braking control processing is executed repeatedly in each predetermined control cycle while the braking command is input.

In the processing of Step S1, the HVECU 8 calculates needed braking electric power based on the brake pedal position signal and determines whether or not the calculated needed braking electric power is equal to or greater than an upper limit value of charging electric power Win permitted for the battery 6. As a result of the determination, when the needed braking electric power is equal to or greater than the upper limit value of the charging electric power Win permitted for the battery 6 (Step S1: Yes), the HVECU 8 progresses the braking control processing to processing of Step S2. When the needed braking electric power falls below the upper limit value of the charging electric power Win permitted for the battery 6 (Step S1: No), the HVECU 8 progresses the braking control processing to processing of Step S5.

In the processing of Step S2, the HVECU 8 calculates braking electric power of the hydraulic brake 7 needed for obtaining the needed braking electric power calculated in the processing of Step S1, braking electric power of the power generation motor MG1, and braking electric power of the drive motor MG2. Specifically, the HVECU 8 calculates a differential value between the needed braking electric power and the upper limit value of the charging electric power Win permitted for the battery 6 and allocates the calculated differential value into the braking electric power of the hydraulic brake 7 and the braking electric power of the power generation motor MG1. Specifically, an engine rotation speed at the time of motoring increases in proportion to a vehicle speed in consideration of in-vehicle noise or outside-vehicle noise. For this reason, the allocation of the differential value is defined in advance such that the power generation motor MG1 can output electric power for friction to balance with the engine rotation speed for motoring. The HVECU 8 sets the upper limit value of the charging electric power Win to the braking electric power of the drive motor MG2. With this, the processing of Step S2 is completed, and the braking control processing progresses to processing of Step S3.

In the processing of Step S3, the HVECU 8 calculates a hydraulic pressure value of the hydraulic brake 7 needed for obtaining the braking electric power of the hydraulic brake 7 calculated in the processing of Step S2. The motor ECU 31 calculates powering torque of the power generation motor MG1 needed for obtaining the braking electric power of the power generation motor MG1 calculated in the processing of Step S2. In addition, the HVECU 8 calculates regenerative torque of the drive motor MG2 needed for obtaining the braking electric power of the drive motor MG2 calculated in the processing of Step S2. With this, the processing of Step S3 is completed, and the braking control processing progresses to processing of Step S4.

In the processing of Step S4, the HVECU 8 controls a hydraulic pressure of the hydraulic brake 7 to the hydraulic pressure value calculated in the processing of Step S3. The motor ECU 31 performs control such that the power generation motor MG1 outputs the powering torque calculated in the processing of Step S3, thereby driving the (performing motoring) of the engine 2. In addition, the motor ECU 31 performs control such that the drive motor MG2 outputs the regenerative torque calculated in the processing of Step S3, thereby performing a regenerative braking operation of the drive motor MG2. With this, the processing of Step S4 is completed, and a series of braking control processing ends.

In the processing of Step S5, the HVECU 8 determines whether or not the rotation speed of the engine 2 exceeds 0 rpm based on the engine rotation speed signal from the engine rotation speed sensor 82. As a result of the determination, when the rotation speed of the engine 2 exceeds 0 rpm (Step S5: Yes), the HVECU 8 progresses the braking control processing to processing of Steps S6 and S9. When the rotation speed of the engine 2 does not exceed 0 rpm (Step S5: No), the HVECU 8 progresses the braking control processing to processing of Step S12.

In the processing of Step S6, the HVECU 8 instructs the motor ECU 31 to implement the needed braking electric power calculated in the processing of Step S1 with the regenerative braking operation of the drive motor MG2. With this, the processing of Step S6 is completed, and the braking control processing progresses to processing of Step S7.

In the processing of Step S7, the motor ECU 31 calculates the regenerative torque of the drive motor MG2 needed for obtaining the needed braking electric power. With this, the processing of Step S7 is completed, and the braking control processing progresses to processing of Step S8.

In the processing of Step S8, the motor ECU 31 performs control such that the drive motor MG2 outputs the regenerative torque calculated in the processing of Step S7, thereby performing the regenerative braking operation of the drive motor MG2. With this, the processing of Step S8 is completed, and a series of braking control processing ends.

In the processing of Step S9, the HVECU 8 instructs the motor ECU 31 to generate the differential value between the upper limit value of the charging electric power Win permitted for the battery 6 and the needed braking electric power calculated in the processing of Step S1 with a regenerative operation of the power generation motor MG1.

With this, the processing of Step S9 is completed, and the braking control processing progresses to processing of Step S10.

In the processing of Step S10, the motor ECU 31 calculates regenerative torque of the power generation motor MG1 needed for generating the differential value between the upper limit value of the charging electric power Win permitted for the battery 6 and the needed braking electric power. With this, the processing of Step S10 is completed, and the braking control processing progresses to processing of Step S11.

In the processing of Step S11, the motor ECU 31 performs control such that the power generation motor MG1 outputs the regenerative torque calculated in the processing of Step S10, thereby regeneratively driving the power generation motor MG1. That is, the motor ECU 31 regeneratively drives the power generation motor MG1 to convert kinetic energy of the engine 2 to electric energy and to charge the battery 6 with the electric energy. With this, the processing of Step S11 is completed, and a series of braking control processing ends.

In the processing of Step S12, the HVECU 8 instructs the motor ECU 31 to implement the needed braking electric power with the regenerative braking operation of the drive motor MG2. With this, the processing of Step S12 is completed, and the braking control processing progresses to processing of Step S13.

In the processing of Step S13, the motor ECU 31 calculates regenerative torque of the drive motor MG2 needed for outputting the needed braking electric power. Then, the motor ECU 31 performs control that the drive motor MG2 outputs the calculated regenerated torque, thereby performing the regenerative braking operation of the drive motor MG2. With this, the processing of Step S13 is completed, and a series of braking control processing ends.

As will be apparent from the above description, in the braking control processing according to the embodiment of the present disclosure, in regenerating with the drive motor MG2 through braking during traveling of the hybrid vehicle 1, when the regenerative electric power amount exceeds the upper limit value of the charging electric power Win permitted for the battery 6, the HVECU 8 converts a surplus of the regenerative electric power to the kinetic energy of the engine 2 employing motoring of the engine 2 with the power generation motor MG1. Then, when the regenerative electric power amount falls below the upper limit value of the charging electric power Win permitted for the battery 6, the HVECU 8 converts the kinetic energy of the engine 2 to the electric energy with the power generation motor MG1 and charges the battery 6 with the electric energy. With this, it is possible to suppress deterioration of fuel efficiency of the hybrid vehicle 1 by consuming the surplus of the regenerative electric power.

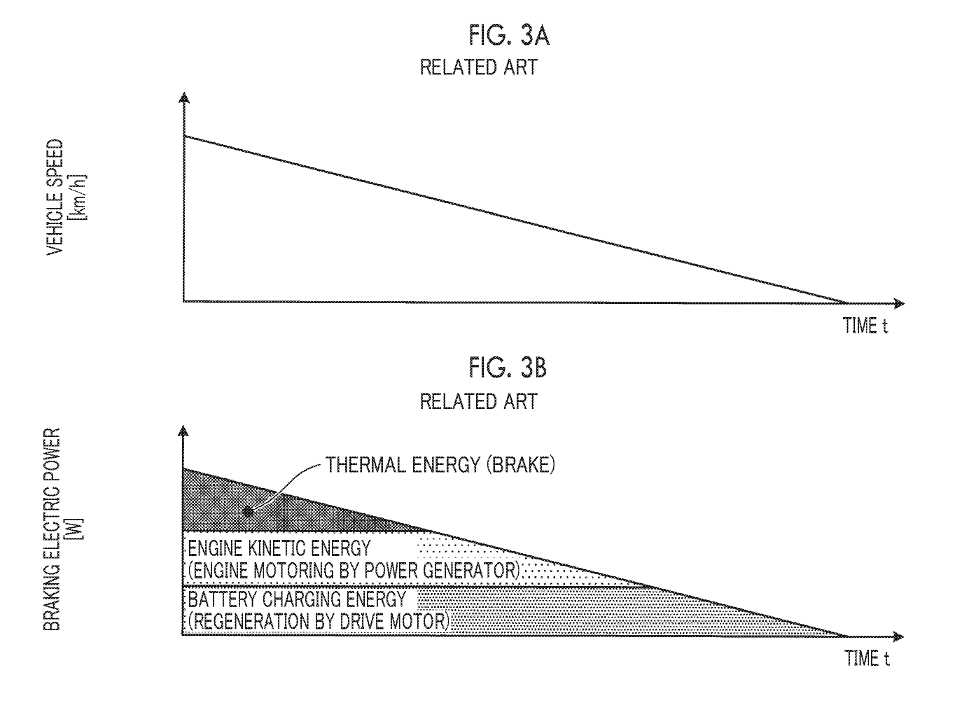

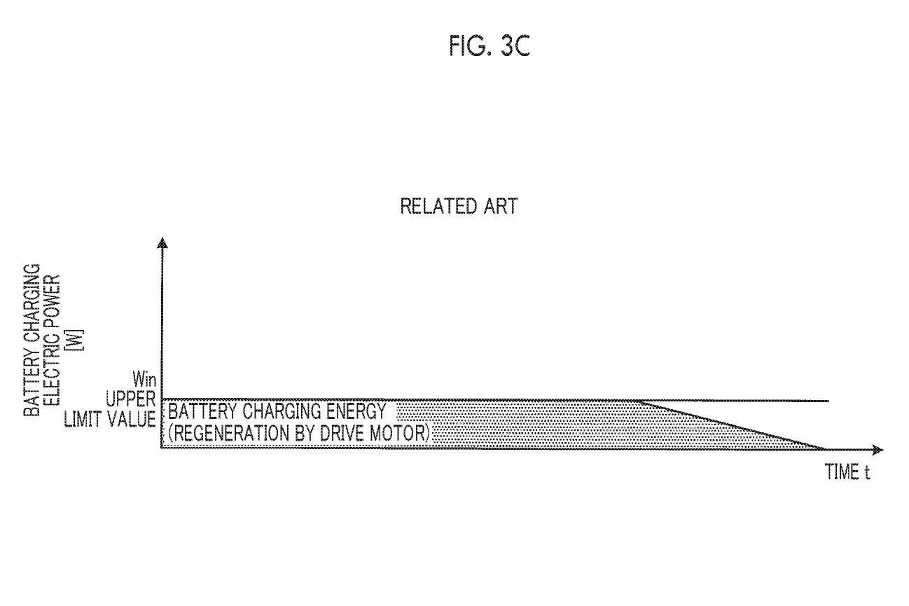

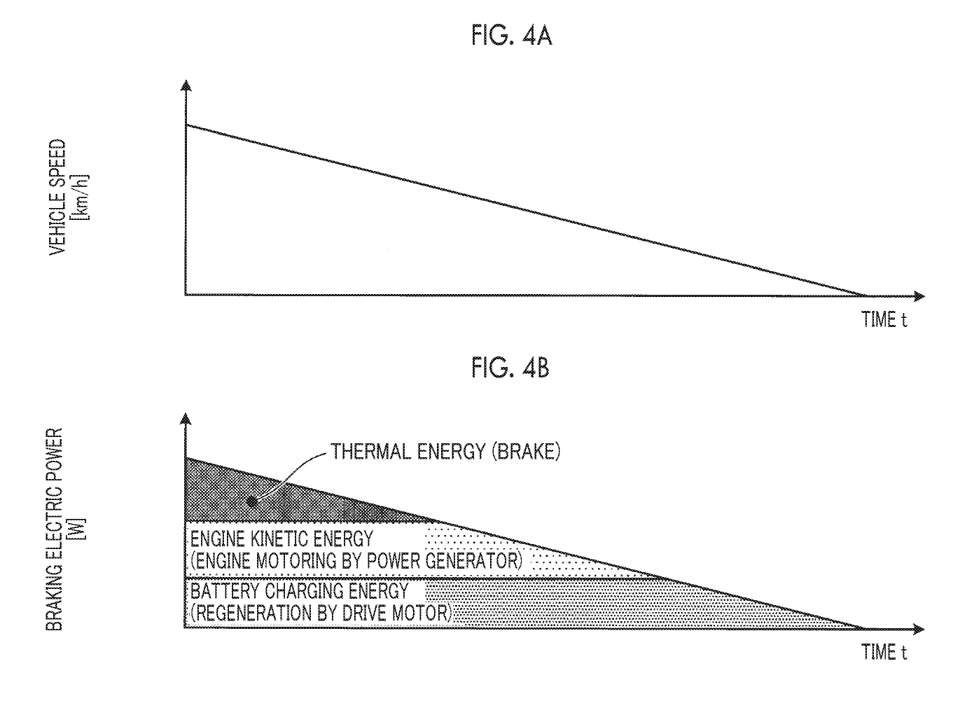

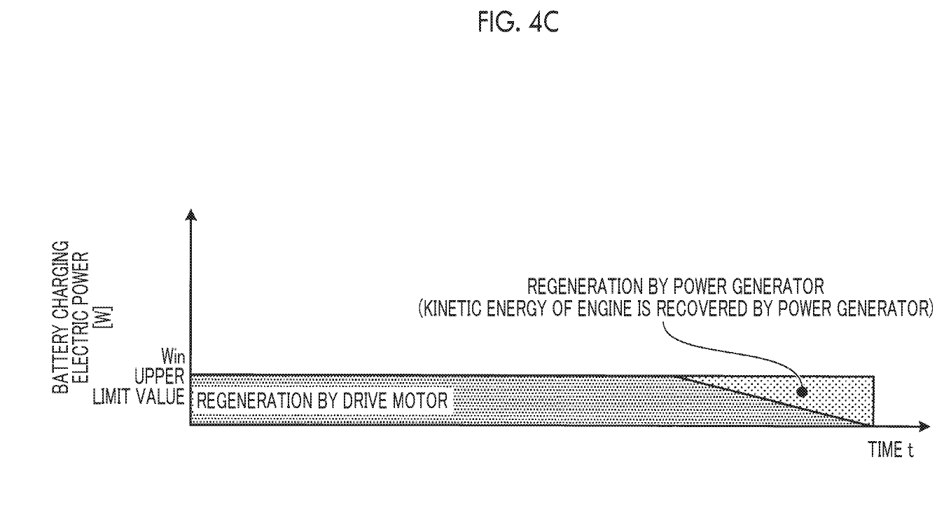

Specifically, in the related art, as shown in FIGS. 3A to 3C, since the kinetic energy of the engine 2 is not recovered even though charging electric power permitted for the battery 6 falls below an upper limit value Max, a surplus of regenerative electric power is consumed wastefully. In contrast, in the braking control processing according to the embodiment of the present disclosure, as shown in FIGS. 4A to 4C, when the charging electric power permitted for the battery 6 falls below the upper limit value Max, the HVECU 8 converts the kinetic energy of the engine 2 to the electric energy with the power generation motor MG1 and charges the battery 6 with the electric energy, it is possible to recover the surplus of the regenerative electric power. With this, it is possible to suppress deterioration of fuel efficiency of the hybrid vehicle 1 by consuming the surplus of the regenerative electric power.

### MODIFICATION EXAMPLE 1

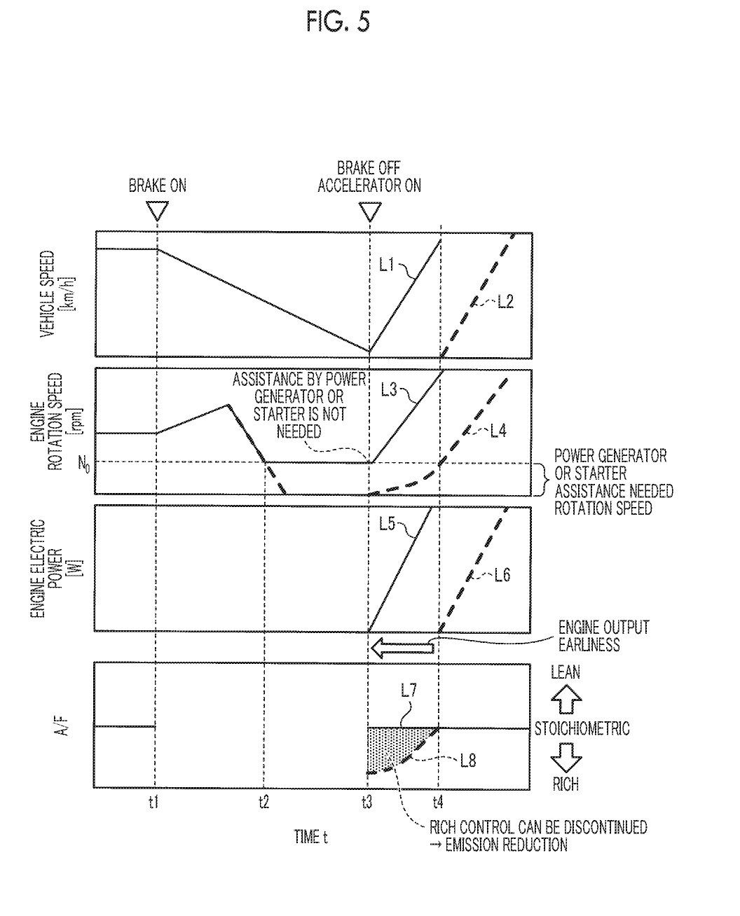

In converting the kinetic energy of the engine 2 to the electric energy, it is desirable that the HVECU 8 converts the kinetic energy of the engine 2 to the electric energy until a predetermined engine rotation speed N₀ outputtable from the engine without assistance of a power generator or a starter and executes motoring of the engine 2 when the engine rotation speed is the predetermined engine rotation speed N₀. Specifically, as shown in FIG. 5, the HVECU 8 starts processing for converting the kinetic energy of the engine 2 to the electric energy at a timing (time t=t1) at which the brake pedal is on and stops the processing for converting the kinetic energy of the engine 2 to the electric energy at a timing (time t=t2) at which the engine rotation speed becomes the predetermined engine rotation speed N₀ outputtable from the engine. Then, the HVECU 8 executes the motoring of the engine 2 at a timing (time t=t3) at which the brake pedal is off and the accelerator pedal is on. Note that solid lines L1, L3, L5, L7 in the drawing indicate a vehicle speed, an engine rotation speed, engine electric power, and an air-fuel ratio (A/F) when the present control is performed, respectively, and broken lines L2, L4, L6, L8 in the drawing indicate the vehicle speed, the engine rotation speed, the engine electric power, and the A/F when the present control is not performed, respectively.

According to such processing, as will be apparent from comparison of the solid line L3 and the broken line L4, since it is possible to start the engine 2 without assistance of the power generator or the starter, it is possible to reduce the output of the battery 6. As will be apparent from comparison of the solid line L5 and the broken line L6, since it is possible to use the engine electric power with excellent responsiveness at the time of a next start, drivability is improved. In addition, as will be apparent from comparison of the solid line L7 and the broken line L8, since there is no need to control fuel to a rich side at the time of an engine start, it is possible to reduce emission.

### MODIFICATION EXAMPLE 2

Before warming-up determination of the engine 2, it is desirable that the HVECU 8 does not execute the motoring of the engine 2 using an excess amount of the charging electric power Win permitted for the battery 6. According to such processing, it is desirable to improve fuel efficiency by quickening warming-up of the engine 2 and introduction of exhaust gas recirculation (EGR).

### MODIFICATION EXAMPLE 3

When a situation (for example, at the time of traveling on a downhill road) in which the excess of the charging electric power Win permitted for the battery 6 is continued for a long time through look-ahead control using a navigation device or the like is predicted, it is desirable that the HVECU 8 starts the motoring of the engine 2 at a predetermined timing before the excess of the charging electric power Win permitted for the battery 6 ends and converts regenerative energy to kinetic energy. According to such processing, it is possible to minimize deterioration of vibration noise (NV) accompanied by increasing the engine rotation speed.

### MODIFICATION EXAMPLE 4

In Modification Example 3, when a state of charge (SOC) of the battery 6 reaches an upper limit value even though a situation in which the excess of the charging electric power Win permitted for the battery 6 is continued for a long time is predicted, it is desirable that the HVECU 8 starts the motoring of the engine 2 and converts energy regenerated by the drive motor MG2 to the kinetic energy of the engine 2 with the power generation motor MG1. When the state of charge of the battery 6 reaches the upper limit value, since the charging electric power Win permitted for the battery 6 becomes zero, there is a need to convert regenerative energy to thermal energy of the brake; however, in this case, there is a possibility that the brake fades and overrun occurs. Therefore, according to such processing, since the energy regenerated by the drive motor MG2 is released to kinetic energy with the power generation motor MG1, it is possible to suppress the occurrence of overrun.

### MODIFICATION EXAMPLE 5

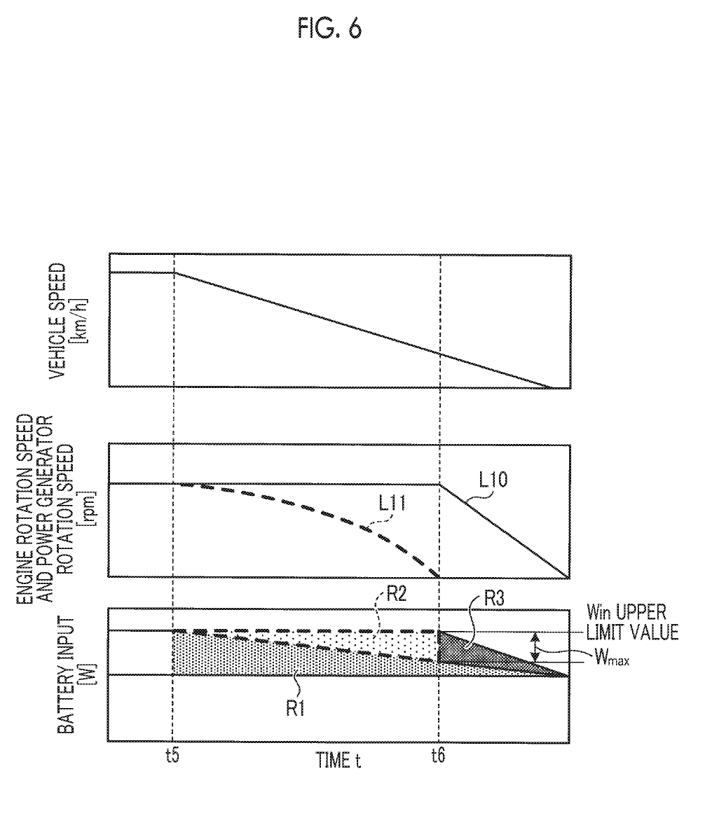

As shown in FIG. 6, when there is an engine stop command at the time of deceleration (time t=t5), it is desirable that the HVECU 8 executes engine stop control after the differential value between the upper limit value of the charging electric power Win permitted for the battery 6 and the regenerative electric power of the drive motor MG2 exceeds maximum electric power Wₘₐₓ needed for the engine stop control (after time t=t6). Note that a solid line L10 in the drawing indicates an engine rotation speed and a rotation speed of the power generation motor MG1 (power generator) when the present control is performed, and a broken line L11 in the drawing indicates an engine rotation speed and a rotation speed of the power generation motor MG1 when the present control is not performed. Furthermore, regions R1, R2, R3 in the drawing indicate regenerative electric power of the drive motor MG2, regenerative electric power of the power generation motor MG1 when the present control is not performed, and regenerative electric power of the power generation motor MG1 when the present control is performed, respectively. According to such processing, traveling energy is recovered to the battery 6 to the maximum, and the engine 2 is stopped quickly, whereby the engine rotation speed passes through a resonance frequency bandwidth of a damper during a stop operation of the engine 2, and it is possible to suppress the occurrence of torque fluctuation or vibration noise of the engine.

Although the embodiment to which the present disclosure made by the present inventors is applied has been described above, an applicable embodiment of the present disclosure is not limited by the description and the drawings as a part of the disclosure of the present disclosure according to the embodiment. That is, all other embodiments, examples, operation techniques, or the like made by those skilled in the art based on the embodiment are embraced in the gist of the present disclosure.

What is claimed is:

1. A control device for a hybrid vehicle including an engine, a battery, a power generation motor connected to an output shaft of the engine, and a drive motor connected to a drive shaft coupled to drive wheels, the control device comprising an electronic control unit configured to
when regenerative electric power of the drive motor exceeds an upper limit value of charging electric power permitted for the battery, perform control such that the power generation motor is power-driven using electric power corresponding to a differential value between the regenerative electric power of the drive motor and the upper limit value of the charging electric power permitted for the battery to rotationally drive the engine, and
when the regenerative electric power of the drive motor falls below the upper limit value of the charging electric power permitted for the battery, perform control such that the power generation motor is regeneratively driven to convert kinetic energy of the engine to electric energy and to charge the battery with the electric energy.

2. The control device according to claim 1, wherein the electronic control unit is configured to, when there is a stop request of the engine at the time of deceleration of the hybrid vehicle, execute stop control of the engine after the differential value between the regenerative electric power of the drive motor and the upper limit value of the charging electric power permitted for the battery exceeds maximum electric power needed for the stop control of the engine.
